(19) United States
(12) Patent Application Publication
(10) Pub. No.: US 2010/0220081 A1
(43) Pub. Date: Sep. 2, 2010

(54) PLASMA PROCESSING APPARATUS

(75) Inventor: Koichi Yatsuda, Tokyo (JP)

Correspondence Address: PEARNE & GORDON LLP, 1801 EAST 9TH STREET, SUITE 1200, CLEVELAND, OH, 44114-3108, US

(73) Assignee: TOKYO ELECTRON LIMITED, Tokyo (JP)

(21) Appl. No.: 12/714,691

(22) Filed: Mar. 1, 2010

(30) Foreign Application Priority Data
Mar. 2, 2009 (JP) 2009-047982

(51) Int. Cl. G09G 3/28; G06F 3/038

(52) U.S. Cl. 345/205; 345/60

(57) ABSTRACT

Provided is a plasma processing apparatus employing a method of applying a DC voltage to a first electrode without installing a facing electrode. A plasma etching apparatus includes an evacuable chamber 10 configured to accommodate a semiconductor wafer W; an upper electrode 34 and a lower electrode 16, on which the semiconductor wafer W is mounted, arranged to face each other within the chamber 10; a processing gas supply unit 66 configured to supply a processing gas into the chamber 10; a first high frequency power supply 48 and a second high frequency power supply 90 configured to apply a high frequency power for plasma generation and a high frequency power for bias application to the lower electrode 16, respectively; and a DC voltage application unit 50 configured to apply a DC voltage alternately changed from positive voltage to negative voltage to the upper electrode 34.

### CROSS-REFERENCE TO RELATED APPLICATION

This application claims the benefit of Japanese Patent Application No. 2009-047982 filed on Mar. 2, 2009, the entire disclosures of which are incorporated herein by reference.

### FIELD OF THE INVENTION

The present disclosure relates to a plasma processing apparatus which performs a plasma process such as plasma etching on a target substrate such as a semiconductor substrate.

### BACKGROUND OF THE INVENTION

For example, in a semiconductor device manufacturing process, there has often been used a plasma etching process, in which a predetermined layer formed on a target substrate such as a semiconductor wafer is etched by plasma, using a resist as a mask in order to form a predetermined pattern on the layer.

Although various kinds of plasma etching apparatuses have been used to perform such a plasma etching process, a plasma etching apparatus of a capacitively coupled parallel plate type has been mainly used.

The capacitively coupled parallel plate type plasma etching apparatus includes a chamber with a pair of parallel plate electrodes (upper and lower electrodes) provided therein. While a processing gas is introduced into the chamber, a high frequency power is applied to at least one of the electrodes to form a high frequency electric field between the electrodes. The processing gas is excited into plasma by the high frequency electric field, thereby performing a plasma etching process on a predetermined layer formed on a semiconductor wafer.

To be specific, there has been known a plasma etching apparatus for generating plasma in a desired state by applying a plasma generation high frequency power having a relatively high frequency and an ion implantation high frequency power having a relatively low frequency. With this apparatus, it is possible to perform an etching process with high selectivity and high reproducibility (for example, see Patent Document 1).

Recently, in order to meet an increasing demand for microprocessing, a film thickness of a photoresist serving as a mask is getting thinner, and the kind of the photoresist is changed from a KrF photoresist to an ArF photoresist. The KrF photoresist is exposed to a laser beam of which a light emitting source is a KrF gas and the ArF photoresist is exposed to a laser beam, having a shorter wavelength, of which a light emitting source is an ArF gas. Further, the ArF photoresist is suitable for forming a finer opening pattern. However, the ArF photoresist has a low plasma resistance. Accordingly, due to the thin thickness of the photoresist together with its low plasma resistance, it is difficult to form etching holes with a sufficient etching selectivity.

Meanwhile, in this kind of the etching apparatus, if a high frequency power for plasma generation applied to the upper electrode is low, a deposit may be adhered to the upper electrode after the etching process, and, thus, there are concerns that degradation of process characteristics or generation of particles would be caused. In contrast, if the power is high, the electrode may be eroded (or worn away), thereby modifying process characteristics from those obtained by the low power. The suitable range of the power from a high frequency power supply is determined depending on the processes, and, thus, it is required that the process characteristics should not be changed regardless of a level of power.

Further, in such a capacitively coupled parallel plate type plasma etching apparatus, if a pressure in the chamber is high and an etching gas in use is a negative gas (such as CxFy or O₂), a plasma density becomes low at a central portion of the chamber, which makes it difficult to control the plasma density.

Furthermore, along with miniaturization and complication of semiconductor devices, it takes considerable time to perform an etching process. Therefore, there is a demand for improvement in etching rate.

As a technique to meet the above-described demands, there has been suggested a technique of applying a DC voltage to the upper electrode (first electrode) of the capacitively coupled parallel plate type plasma etching apparatus (see Patent Document 2). This technique makes it possible to solve the above-described problems by at least one of (1) the effect of sputtering the surface of the upper electrode (first electrode), which is obtained by increasing an absolute value of a self-bias voltage of the upper electrode (first electrode); (2) the effect of contracting the plasma, which is obtained by expanding a plasma sheath on the upper electrode (first electrode); (3) the effect of irradiating electrons generated near the upper electrode (first electrode) onto the semiconductor wafer as a target substrate; (4) the effect of controlling a plasma potential; (5) the effect of increasing an electron (plasma) density; and (6) the effect of increasing a plasma density at a central portion.

Patent Document 1: Japanese Patent Laid-open Publication No. 2000-173993

Patent Document 2: Japanese Patent Laid-open Publication No. 2006-270017

### BRIEF SUMMARY OF THE INVENTION

In Patent Document 2, it is necessary to install a facing DC electrode made of a conductor in order to prevent plasma instability or abnormal electric discharge when the DC voltage is applied to the upper electrode. However, such a facing electrode is a consumable of a relatively high price and thus a high running cost is required.

In view of the foregoing, the present disclosure provides a plasma processing apparatus employing a method of applying a DC voltage to a first electrode without installing such a facing electrode.

In accordance with an aspect of the present disclosure, there is provided a plasma processing apparatus including: an evacuable processing chamber configured to accommodate a target substrate; a first electrode and a second electrode arranged to face each other within the processing chamber, the second electrode being configured to mount the target substrate; a processing gas supply unit configured to supply a processing gas into the processing chamber; a high frequency power application unit configured to apply a high frequency power to at least one of the first and second electrodes; and a DC voltage application unit configured to apply a DC voltage alternately changed from positive voltage to negative voltage to the first electrode.

In the plasma processing apparatus, it is desirable that the DC voltage may be applied in a pulse pattern. In this case, it is desirable that a frequency of the applied DC voltage alternately changed from positive voltage to negative voltage may be in a range from about 1 to about 100 kHz. Further, it is desirable that when positive and negative voltages are alternately applied, a duty ratio of the negative voltage may range from about 50% to about 90%.

Further, it is desirable that values of the positive and negative voltages may be in a range from about −6000 V to about +6000 V. Furthermore, it is desirable that a value of the positive voltage may be equal to or higher than a value of the negative voltage.

Further, the high frequency power application unit may include a high frequency power supply for plasma generation and a high frequency power supply for bias application, both of which are connected with the second electrode. Furthermore, the high frequency power application unit may include a high frequency power supply for plasma generation which is connected with the first electrode and a high frequency power supply for bias application which is connected with the second electrode.

In accordance with the present disclosure, a DC voltage alternately changed from positive to negative is applied to a first electrode serving as a facing electrode of a target object by a DC voltage application unit in a capacitively coupled parallel plate type plasma etching apparatus, and, thus, electric charges are not easily accumulated in a processing chamber. Therefore, it is possible to obtain a plasma processing apparatus capable of preventing plasma instability or abnormal electric discharge without installing the facing electrode.

### BRIEF DESCRIPTION OF THE DRAWINGS

The disclosure may best be understood by reference to the following description taken in conjunction with the following figures:

FIG. 1 is a schematic cross-sectional view of a plasma etching apparatus capable of performing a plasma etching method of the present disclosure;

FIG. 2 is a view showing a pattern of a voltage applied by a DC voltage application unit;

FIG. 3 is a view showing a configuration of a first matching unit connected with a first high frequency power supply of the plasma etching apparatus of FIG. 1;

FIGS. 4A and 4B are diagrams showing a state where a negative voltage is applied by a DC voltage application unit and a state where a positive voltage is applied by the DC voltage application unit;

FIG. 5 is a schematic cross-sectional view of another plasma etching apparatus capable of performing a plasma etching method of the present disclosure; and

FIG. 6 is a view showing a configuration of a first matching unit connected with a first high frequency power supply of the plasma etching apparatus of FIG. 5.

### DETAILED DESCRIPTION OF THE INVENTION

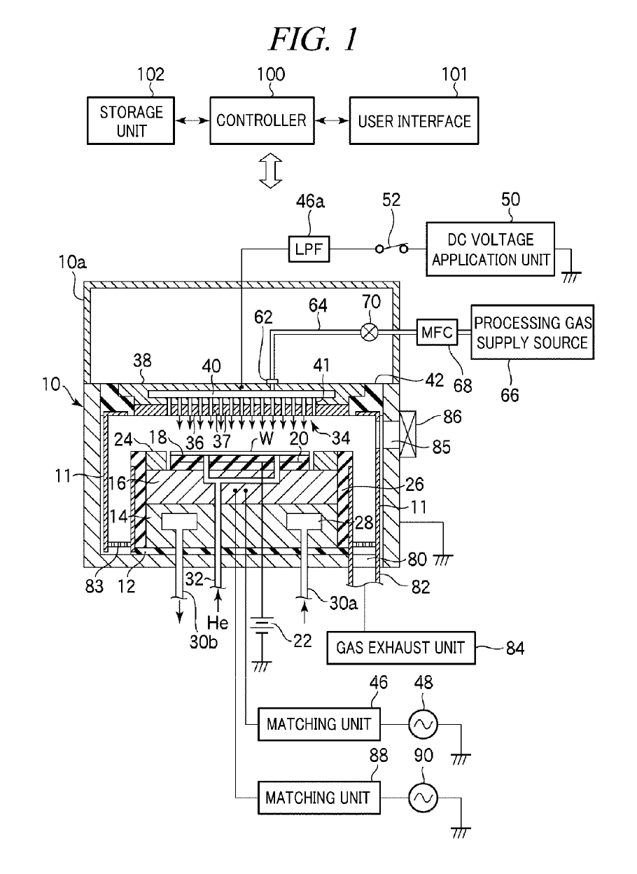

Hereinafter, embodiments of the present disclosure will be described in detail with reference to the accompanying drawings. There will be explained an example of employing a plasma etching apparatus as a plasma processing apparatus of the present disclosure. FIG. 1 is a schematic cross-sectional view of a plasma etching apparatus serving as a plasma processing apparatus in accordance with an embodiment of the present disclosure.

This plasma etching apparatus is configured as a capacitively coupled parallel plate type plasma etching apparatus and includes a substantially cylindrical chamber (processing vessel) 10 made of, e.g., aluminum with an anodically oxidized surface. The chamber 10 is frame-grounded.

A cylindrical susceptor support 14 is installed on a bottom of the chamber 10, with an insulating plate 12 made of ceramic therebetween. On the susceptor support 14, a susceptor 16 made of, e.g., aluminum is installed. The susceptor 16 serves as a lower electrode, and a semiconductor wafer W as a target substrate is mounted thereon.

On a top surface of the susceptor 16, an electrostatic chuck 18 for attracting and holding the semiconductor wafer W by an electrostatic force is installed. This electrostatic chuck 18 is configured to have an electrode 20 formed of a conductive film between a pair of insulating layers or insulating sheets and the electrode 20 is electrically connected with a DC power supply 22. The semiconductor wafer W is attracted and held on the electrostatic chuck 18 by an electrostatic force such as a Coulomb force generated by a DC voltage from the DC power supply 22.

A conductive focus ring (correction ring) 24 made of, e.g., a silicon, for improving an etching uniformity is provided on the top surface of the susceptor 16 around the electrostatic chuck 18 (semiconductor wafer W). At a side surface of the susceptor 16 and the susceptor support 14, a cylindrical inner wall member 26 made of, e.g., quartz is installed.

For example, a coolant reservoir 28 is provided within the susceptor support 14 along the circumference of the susceptor support 14. A coolant such as cooling water of a predetermined temperature is supplied and circulated from a non-illustrated chiller unit, which is installed outside the plasma etching apparatus, into the coolant reservoir 28 through coolant lines 30a and 30b. Accordingly, it is possible to control a processing temperature of the semiconductor wafer W on the susceptor 16 by the coolant.

Furthermore, a heat transfer gas such as a He gas is supplied into between a top surface of the electrostatic chuck 18 and a rear surface of the semiconductor wafer W from a non-illustrated heat transfer gas supply unit through a gas supply line 32.

Above the susceptor 16 serving as a lower electrode, an upper electrode 34 is positioned so as to face the susceptor 16 in parallel. A space between the upper and lower electrodes 34 and 16 is a plasma generation space. The upper electrode 34 has a surface (facing surface) facing the semiconductor wafer W on the susceptor 16 serving as a lower electrode, and this facing surface is in contact with the plasma generation space.

The upper electrode 34 is supported at the top of the chamber 10 by an insulating shield member 42. The upper electrode 34 includes: an electrode plate 36, which is formed as a surface facing the susceptor 16, having a plurality of gas discharge holes 37; and an electrode support 38 for detachably supporting the electrode plate 36. The electrode support 38 is made of a conductive material such as aluminum and has a water-cooling structure. The electrode plate 36 is desirably made of conductor or a semiconductor of a low resistance with low Joule's heat, and it is also desirable to be made of a silicon-containing material in order to reinforce a resist as described below. To be specific, the electrode plate 36 is desirably made of silicon or SiC. The electrode support 38 includes therein a gas diffusion space 40, and a plurality of gas through holes 41 communicated with the gas discharge holes 37 are extended downwardly from the gas diffusion space 40.

On the electrode support 38, there is provided a gas inlet 62 for introducing a processing gas into the gas diffusion space 40, and the gas inlet 62 is connected with a gas supply line 64. The gas supply line 64 is connected with a processing gas supply source 66. Further, there are provided a mass flow controller (MFC) 68 and an opening/closing valve 70 in sequence from an upstream side of the gas supply line 64 (FCS may be installed instead of MFC). A fluorocarbon gas (CxFy), such as C₄F₈ gas, as a processing gas for etching is supplied from the processing gas supply source 66 into the gas diffusion space 40 through the gas supply line 64 and then the fluorocarbon gas is discharged into the plasma generation space via the gas through holes 41 and the gas discharge holes 37, as in a shower device. That is, the upper electrode 34 functions as a shower head for supplying the processing gas.

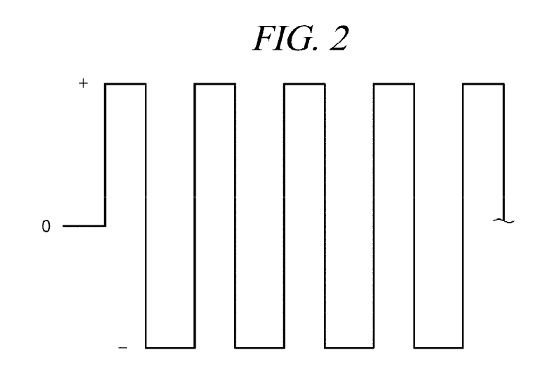

The upper electrode 34 is electrically connected with a DC voltage application unit 50 via a low pass filter (LPF) 46a. The DC voltage application unit 50 is configured to apply a DC voltage, which is alternately changed from positive voltage to negative voltage as illustrated in FIG. 2, in a typical pulse pattern. When a negative voltage is applied, at least one of the following effects can be achieved: (1) the effect of sputtering the surface of the upper electrode, which is obtained by increasing an absolute value of a self-bias voltage of the upper electrode 34; (2) the effect of contracting the plasma, which is obtained by expanding a plasma sheath on the upper electrode 34; (3) the effect of irradiating secondary electrons generated near the upper electrode 34 onto the semiconductor wafer serving as a target substrate by collision of positive ions in the plasma against the upper electrode 34; (4) the effect of controlling a plasma potential; (5) the effect of increasing an electron (plasma) density; and (6) the effect of increasing a plasma density at a central portion. A power supply from the DC voltage application unit 50 can be controlled to be on/off by an on/off switch 52.

It is desirable that the DC voltage application unit 50 may alternately apply positive and negative voltages at a frequency ranging from about 1 to about 100 kHz. Further, it is desirable that a duty ratio of the negative voltage ranges from about 50 to about 90% when the positive and negative voltages are alternately applied. Furthermore, it is desirable that values of the positive and negative voltages are in the range from about −6000 V to about +6000 V. Moreover, it is desirable that the positive voltage value is equal to or higher than the negative voltage value. Details of these conditions will be described below.

The low pass filter (LPF) 46a traps high frequency components outputted from a first and a second high frequency power supply which will be described later and may include an LR filter or an LC filter.

There is installed a cylindrical ground conductor 10a which extends upwardly from a sidewall of the chamber 10 to be higher than the height of the upper electrode 34.

The susceptor 16 serving as a lower electrode is electrically connected with a first high frequency power supply 48 via a first matching unit 46. The first high frequency power supply 48 outputs a high frequency power in the range from about 27 to about 100 MHz, for example, 40 MHz. The first matching unit 46 matches a load impedance with an internal (or output) impedance of the first high frequency power supply 48. When plasma is generated within the chamber 10, the first matching unit 46 makes the output impedance of the first high frequency power supply 48 and the load impedance apparently matched with each other.

Further, the susceptor 16 serving as a lower electrode is electrically connected with a second high frequency power supply 90 via a second matching unit 88. A high frequency power is supplied from the second high frequency power supply 90 to the susceptor 16 serving as a lower electrode, and, thus, a high frequency bias is applied to the semiconductor wafer W and ions are implanted into the semiconductor wafer W. The second high frequency power supply 90 outputs a high frequency power in the range from about 400 kHz to about 13.56 MHz, for example, 3 MHz. The second matching unit 88 matches a load impedance with an internal (or output) impedance of the second high frequency power supply 90. When plasma is generated within the chamber 10, the second matching unit 88 makes the internal impedance of the second high frequency power supply 90 and the load impedance including the plasma within the chamber 10 apparently matched with each other.

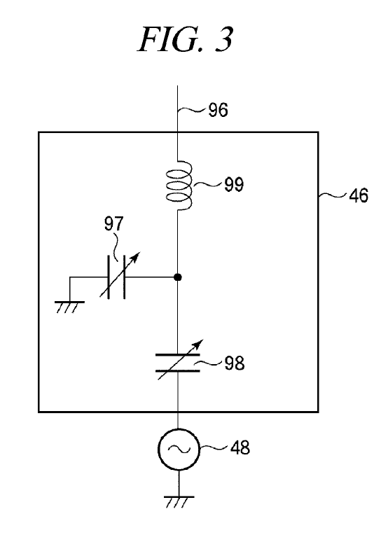

As illustrated in FIG. 3, the first matching unit 46 includes a first variable capacitor 97 branched from a branch point on a power feed line 96 of the first high frequency power supply 48, a second variable capacitor 98 provided between the branch point of the power feed line 96 and the first high frequency power supply 48, and a coil 99 provided opposite to the branch point. The second matching unit 88 is configured basically in the same manner as the first matching unit 46.

Installed at a bottom portion of the chamber 10 is an exhaust port 80, which is connected with a gas exhaust unit via an exhaust line 82. The gas exhaust unit 84 is configured to depressurize the inside of the chamber 10 to a predetermined vacuum level with a vacuum pump such as a turbo-molecular pump. Further, provided at the sidewall of the chamber 10 is a loading/unloading port 85 for the semiconductor wafer W. The loading/unloading port 85 can be opened and closed by a gate valve 86. Furthermore, detachably installed along an inner wall of the chamber 10 is a deposition shield 11 that prevents an etching byproduct (deposit) from being deposited onto the chamber 10. That is, the deposition shield 11 forms a chamber wall. The deposition shield 11 is also installed at an outer periphery of the inner wall member 26. At a bottom portion of the chamber 10, there is provided an exhaust plate 83 between the deposition shield 11 of the chamber wall and the deposition shield 11 of the inner wall member 26. The deposition shield 11 and the exhaust plate 83 can be made of an aluminum material coated with ceramic such as Y₂O₃.

Each component of the plasma etching apparatus, such as power supply system or gas supply system, a driving unit, the DC voltage application unit 50, the first high frequency power 48, the second high frequency power supply 90, or the matching units 46 and 88, is configured to be connected with and controlled by a controller (overall control unit) 100 including a microprocessor (computer). The controller 100 is connected with a user interface 101 including a keyboard through which an operator inputs a command to manage the plasma etching apparatus and a display on which an operation status of the plasma etching apparatus is displayed.

Further, the controller 100 is connected with a storage unit 102 for storing therein: a control program by which the controller 100 controls various kinds of processes performed in the plasma etching apparatus; and a program, i.e., a processing recipe, which allows each component of the plasma etching apparatus to perform a process according to a processing condition. The processing recipe is stored in a storage medium of the storage unit 102. The storage medium may be a hard disc or a semiconductor memory, or may be a portable medium such as a CD-ROM, a DVD, and a flash memory. Alternatively, the processing recipe may be appropriately received from an external apparatus through a dedicated line.

If necessary, a required recipe is retrieved from the storage unit 102 and executed by the controller 100 in response to an instruction from the user interface 101, whereby a predetermined process is performed in the plasma etching apparatus under the control of the controller 100. The plasma etching apparatus described in the embodiments of the present disclosure may include this controller 100.

Hereinafter, there will be explained an operation of the plasma etching apparatus configured as stated above. With the gate valve 86 open, the semiconductor wafer W is loaded into the chamber 10 through the loading/unloading port 85 and mounted on the susceptor 16. Then, the processing gas is supplied from the processing gas supply source 66 into the gas diffusion space 40 at a predetermined flow rate and then introduced into the chamber 10 through the gas through holes 41 and the gas discharge holes 37. At the same time, the inside of the chamber 10 is evacuated by the gas exhaust unit 84 so as to set a internal pressure of the chamber 10 to be in the range of, e.g., about 0.1 Pa to about 150 Pa. In this state, to the susceptor serving as a lower electrode, the first high frequency power supply 48 applies a high frequency power for plasma generation with a relatively high frequency ranging from about 27 to about 100 MHz, e.g., 40 MHz and the second high frequency power supply 90 applies a high frequency power for ion implantation with a frequency ranging from about 400 kHz to about 13.26 MHz, e.g., 3 MHz lower than the frequency of the high frequency power for plasma generation. Meanwhile, to the upper electrode 34, the DC voltage application unit 50 applies a DC voltage alternately changed from positive voltage to negative voltage. Therefore, a plasma etching process is performed on the semiconductor wafer W. At this time, the semiconductor wafer W is held onto the electrostatic chuck 18 by the DC voltage applied from the DC power supply 22 to the electrode 20 of the electrostatic chuck 18.

In this case, it may be possible to use conventional gases as a processing gas. For example, a halogen-containing gas, typically, a fluorocarbon gas (CxFy) such as C₄F₈ can be used. Further, the processing gas may include another gas such as an Ar gas or an O₂ gas.

The processing gas discharged from the gas discharge holes 37 formed in the electrode plate 36 of the upper electrode 34 is excited into plasma during a glow discharge generated by a high frequency power between the upper electrode 34 and the susceptor 16 serving as a lower electrode. A predetermined film on the semiconductor wafer W is plasma etched by positive ions or radicals generated in this plasma.

At this time, the plasma can be generated closer to the wafer W and the plasma is not diffused widely by applying the high frequency power for plasma generation to the lower electrode, and, thus, dissociation of the processing gas can be suppressed. Accordingly, even under condition that the internal pressure of the chamber 10 is high and the plasma density is low, it is possible to increase an etching rate. Further, even in case that the high frequency power for plasma generation has a high frequency, it is possible to obtain a relatively high ion energy with high efficiency. Since the high frequency power for plasma generation and the high frequency power for ion implantation are separately applied to the lower electrode as described in the present embodiment, it is possible to independently control the plasma generation and the ion implantation, which are required for plasma etching. Accordingly, it is possible to meet the conditions of an etching process requiring high microprocessing. Further, since a plasma generation high frequency power having a high frequency of about 27 MHz or higher is supplied, it is possible to increase density of plasma in a desired state, and, thus, even under the lower pressure condition, it is possible to generate high-density plasma.

As described above, when the plasma is generated, the DC voltage application unit 50 applies the DC voltage, alternately changed from positive to negative, to the upper electrode 34. In this case, when a negative voltage is applied, at least one of the following effects can be achieved: (1) the effect of sputtering the surface of the upper electrode, which is obtained by increasing an absolute value of a self-bias voltage of the upper electrode 34; (2) the effect of contracting the plasma, which is obtained by expanding a plasma sheath on the upper electrode 34; (3) the effect of irradiating electrons generated near the upper electrode 34 onto the semiconductor wafer serving as a target substrate by collision of positive ions in the plasma against the upper electrode 34; (4) the effect of controlling a plasma potential; (5) the effect of increasing an electron (plasma) density; and (6) the effect of increasing a plasma density at a central portion.

With the above-described effect (1), even if polymers generated by a processing gas or polymers from a photoresist are deposited on the upper electrode 34's surface, the polymers can be sputtered, thereby cleaning up the upper electrode 34's surface. At the same time, optimum polymers can be supplied onto the semiconductor wafer W, whereby a roughness of the photoresist film can be suppressed.

With the above-described effect (2), an effective residence time on the semiconductor wafer W is decreased and the plasma concentrates on the semiconductor wafer W with less diffusion, thereby contracting an evacuation space. Therefore, dissociation of a fluorocarbon-based processing gas is suppressed, and, thus, an organic mask such as a photoresist is less etched.

With the above-described effect (3), a composition of a mask on the semiconductor wafer W is modified, and, thus, the roughness of the photoresist film can be suppressed. Further, since the electrons at a high velocity are irradiated onto the semiconductor wafer W, a shading effect is suppressed, thereby improving microprocessing performance on an etching target film of the semiconductor wafer W.

With the above-described effect (4), the plasma potential can be suitably controlled to prevent the etching byproducts from being deposited on members such as insulating members inside the chamber 10, the electrodes or the chamber wall (deposition shield).

With the above-described effect (5), the etching rate (etching speed) on the target substrate can be increased. Further, with the above-described effect (6), even if the pressure within the chamber 10 is high and the employed etching gas is a negative gas, the plasma density is prevented from being lowered at the central portion than at the peripheral portions within the processing chamber (i.e., generation of negative ions can be suppressed). Therefore, the plasma density can be controlled to be uniform.

However, if the negative voltage is continuously applied to the upper electrode 34 when there is no facing DC electrode made of a conductor within the chamber 10, electric charges are accumulated on the members within the chamber 10, thereby causing plasma instability or abnormal electric discharge. For this reason, Patent Document 2 discloses a technique of installing a facing electrode (GND block) which is made of a DC-grounded conductor in order to prevent the electric charges from being accumulated within the chamber 10.

However, such a facing electrode is a consumable of relatively high price and thus a high running cost is required.

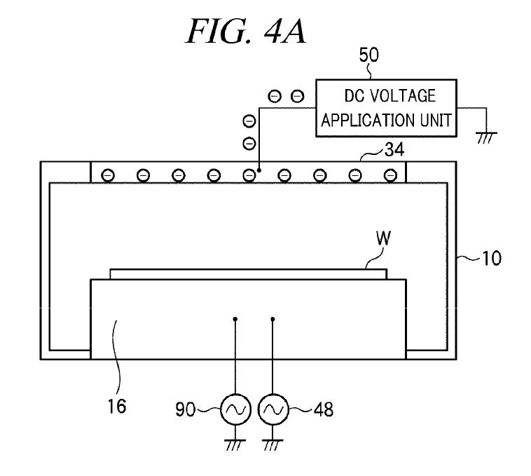

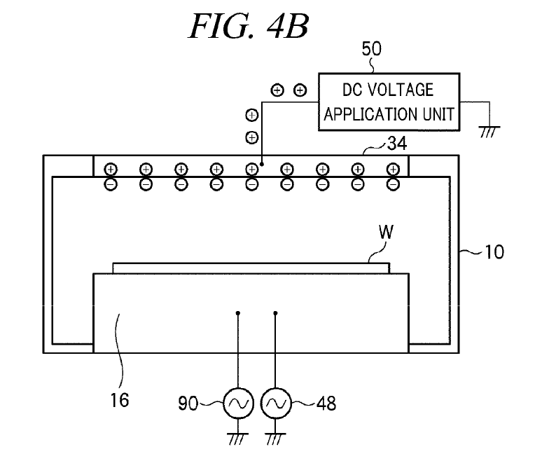

In the present embodiment, such a problem has been solved by connecting the upper electrode 34 with the DC voltage application unit 50 which applies a DC voltage alternately changed from positive to negative. That is, if the DC voltage alternately changed from positive to negative is applied, the DC voltage application unit 50 exhibits the above-described effect by flowing a negative DC current to the upper electrode 34 while a negative voltage is applied as illustrated in FIG. 4A, and then negative electric charges generated within the chamber 10 can be cancelled by applying a positive voltage to flow a positive DC current to the upper electrode 34 as illustrated in FIG. 4B. Accordingly, it is possible to suppress accumulation of the negative electric charges within the chamber 10, and, thus, it is possible to prevent plasma instability or abnormal discharge without installing such a facing DC electrode in the chamber 10.

In this case, it is desirable that the DC voltage application unit 50 outputs a frequency alternately changed from positive to negative in the range from about 1 to about 100 kHz. With the frequency in this range, it is possible to prevent the electric charges from being accumulated, and at the same time, it is possible to obtain the above-described effect of applying the negative DC voltage. Further, it is desirable that duty ratio of the negative voltage ranges from about 50 to about 90% when the positive and negative voltages are alternately applied. If less than about 50%, a time for applying the negative DC voltage becomes short, and, thus, the above-described effect can not be sufficiently obtained. If more than about 90%, it is difficult to cancel the negative electric charges accumulated within the chamber 10. Furthermore, it is desirable that values of the positive and negative voltages are in the range from about −6000 V to about +6000 V. This is because that if plasma potential (Vpp) has an absolute maximum value of about 6000 V and the voltage value is about −6000 V, almost 100% of the secondary electrons can act upon the semiconductor wafer W. Moreover, it is desirable that the positive voltage value is equal to or higher than the negative voltage value. This is because that the duty ratio of the negative voltage is desirably in the range from about 50 to about 90%, and, thus, the positive voltage value needs to be equal to or higher than the negative voltage value in order to cancel the negative electric charges in this range. Besides, although the voltage applied from the DC voltage application unit 50 is desirable to be as high as possible, an electric current from the DC voltage application unit 50 does not always flow in one direction but a polarity of the voltage is reversed after a certain amount of the electric charges are provided to the chamber 10. Accordingly, an efficient power supply need not be employed as the DC voltage application unit 50. Therefore, cost-down can be expected.

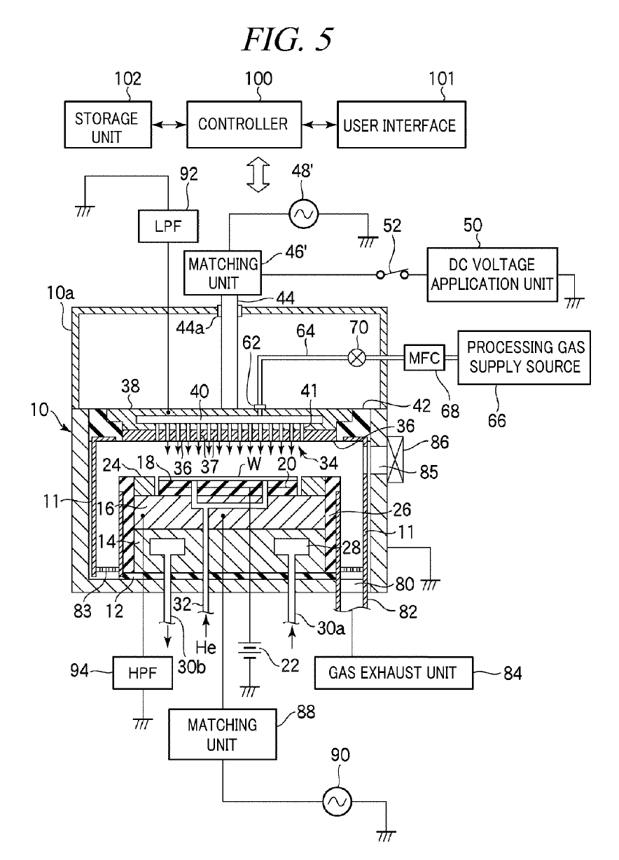

Hereinafter, there will be explained another plasma etching apparatus capable of performing a plasma etching method of the present disclosure. FIG. 5 is a schematic cross-sectional view of another plasma etching apparatus capable of performing a plasma etching method of the present disclosure.

This plasma etching apparatus is different from the apparatus illustrated in FIG. 1 in that the former is configured to apply a high frequency power for plasma generation to an upper electrode, but the other parts of this plasma etching apparatus are the same as those of the plasma etching apparatus described in the first embodiment. Therefore, same parts will be assigned same reference numerals and redundant description thereof will be omitted.

In the present embodiment, a first high frequency power supply 48′ for plasma generation is connected with an upper electrode 34 via a first matching unit 46′ and a power feed rod 44. The first high frequency power supply 48′ has the same function as the first high frequency power supply 48 in the first embodiment. A frequency of the first high frequency power supply 48′ is desirable to be in the range from about 27 to about 100 MHz. The first matching unit 46′ matches a load impedance with an internal (or output) impedance of the first high frequency power supply 48′. When plasma is generated within a chamber 10, the first matching unit 46′ makes the output impedance of the first high frequency power supply 48′ and the load impedance apparently matched with each other. An output terminal of the first matching unit 46′ is connected with an upper end of the power feed rod 44. Further, a DC voltage application unit 50 is connected with the upper electrode 34 via the first matching unit 46′ and the power feed rod 44.

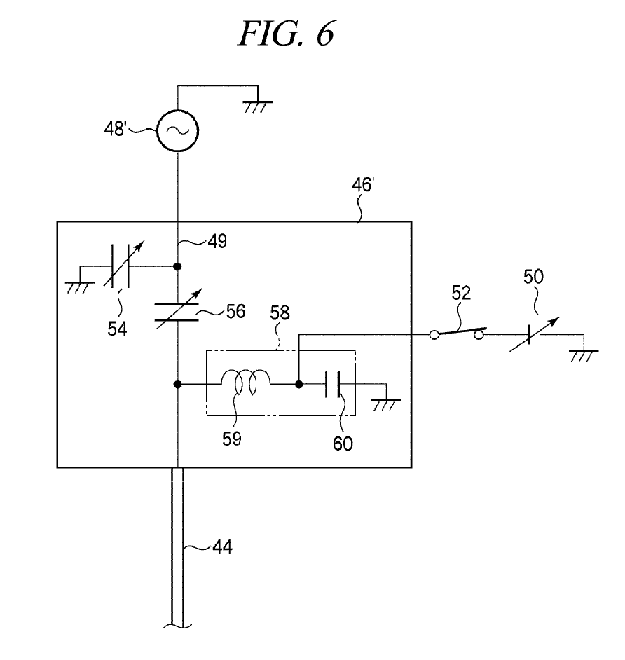

As depicted in FIG. 6, the first matching unit 46′ includes a first variable capacitor 54 branched from a branch point on a power feed line 49 of the first high frequency power supply 48′, a second variable capacitor 56 provided at a downstream side of the branch point of the power feed line 49. With these components, the first matching unit 46′ exhibits the above-described function. Further, the first matching unit 46′ includes therein a filter 58 that traps a high frequency power (e.g., about 40 MHz) from the first high frequency power 48′ and a high frequency power (e.g., about 3 MHz) from a second high frequency power supply 90 such that a DC voltage current (hereinafter, simply referred to as “DC voltage”) can be efficiently applied to the upper electrode 34. That is, a DC current from the DC voltage application unit 50 flows through the filter 58 to the power feed line 49. The filter 58 includes a coil 59 and a capacitor 60 which trap a high frequency power from the first high frequency power supply 48′ and a high frequency power from the second high frequency power supply 90. Furthermore, there is installed a cylindrical insulating member 44a between a ceiling wall portion of a cylindrical ground conductor 10a and the power feed rod 44. The power feed rod 44 and the ground conductor 10a are electrically insulated by this insulating member 44a.

The upper electrode 34 is electrically connected with a low pass filter (LPF) 92 which does not allow the high frequency power (e.g., about 40 MHz) from the first high frequency power supply 48′ to pass therethrough but allows the high frequency power (e.g., about 3 MHz) from the second high frequency power supply 90 to pass through to the ground. The low pass filter (LPF) 92 may include an LR filter or an LC filter. Since it is possible to provide sufficient reactance to the high frequency power (about 60 MHz) from the first high frequency power supply 48′ through only one conducting wire, no further installation is necessary. Meanwhile, a susceptor 16 serving as a lower electrode is electrically connected with a high pass filter (HPF) 94 that allows the high frequency power (e.g., about 40 MHz) from the first high frequency power supply 48′ to pass through to the ground.

In the plasma etching apparatus illustrated in FIG. 5, plasma is generated by applying a high frequency power for plasma generation from the first high frequency power supply 48′ to the upper electrode 34. Further, since a DC voltage alternately changed from positive to negative is applied, at least one of the following effects can be achieved: (1) the effect of sputtering the surface of the upper electrode, which is obtained by increasing an absolute value of a self-bias voltage of the upper electrode 34; (2) the effect of contracting the plasma, which is obtained by expanding a plasma sheath on the upper electrode 34; (3) the effect of irradiating electrons generated near the upper electrode 34 onto the semiconductor wafer serving as a target substrate by collision of positive ions in the plasma against the upper electrode 34; (4) the effect of controlling a plasma potential; (5) the effect of increasing an electron (plasma) density; and (6) the effect of increasing a plasma density at a central portion. Furthermore, it is possible to suppress accumulation of negative electric charges within the chamber 10. Therefore, it is possible to prevent plasma instability or abnormal discharge without installing a facing DC electrode in the chamber 10.

In the apparatus illustrated in FIG. 5, the first high frequency power for plasma generation is supplied to the upper electrode 34 and the second high frequency power for ion implantation is supplied to the susceptor 16 serving as a lower electrode, and, thus, a plasma control margin can be set broader. Further, since the high frequency power having a high frequency of about 27 MHz or higher is supplied to the upper electrode 34, it is possible to increase density of plasma in a desired state, and, thus, even under the lower pressure condition, it is possible to generate high-density plasma.

In the above-described embodiments, a frequency of the first high frequency power may be, but not limited to, about 27 MHz, 40 MHz, 60 MHz, 80 MHz, or 100 MHz, and a frequency of the second high frequency power may be, but not limited to, about 400 kHz, 800 kHz, 1 MHz, 2 MHz, 3 MHz, 13 MHz, or 13.6 MHz. Suitable combination thereof can be selected depending on the process.

Although the embodiments of the present invention have been described above, the present invention is not limited thereto and various changes and modifications can be made without changing technical conception and essential features of the present invention. The above-described embodiments merely show examples of the apparatus. Therefore, the configuration of the apparatus can be modified in any way if a high frequency power is applied to at least one of the upper and lower electrodes and a DC voltage alternately changed from positive to negative is applied to the upper electrode. Further, in the above-described embodiments, the present invention is applied to a plasma etching process, but it can be also applied to any other plasma process. Furthermore, there is no limit on a configuration of a target substrate, and the target substrate is not limited to a semiconductor wafer and, thus, other substrates such as a flat panel display (FPD) can be used therefor.

What is claimed is:

1. A plasma processing apparatus comprising:
an evacuable processing chamber configured to accommodate a target substrate;
a first electrode and a second electrode arranged to face each other within the processing chamber, the second electrode being configured to mount the target substrate;
a processing gas supply unit configured to supply a processing gas into the processing chamber;
a high frequency power application unit configured to apply a high frequency power to at least one of the first and second electrodes; and
a DC voltage application unit configured to apply a DC voltage alternately changed from positive voltage to negative voltage to the first electrode.

2. The plasma processing apparatus of claim 1, wherein the DC voltage is applied in a pulse pattern.

3. The plasma processing apparatus of claim 2, wherein a frequency of the applied DC voltage alternately changed from positive voltage to negative voltage is in a range from about 1 to about 100 kHz.

4. The plasma processing apparatus of claim 2, wherein, when positive and negative voltages are alternately applied, a duty ratio of the negative voltage ranges from about 50% to about 90%.

5. The plasma processing apparatus of claim 1, wherein values of the positive and negative voltages are in a range from about −6000 V to about +6000 V.

6. The plasma processing apparatus of claim 1, a value of the positive voltage is equal to or higher than a value of the negative voltage.

7. The plasma processing apparatus of claim 1, wherein the high frequency power application unit includes a high frequency power supply for plasma generation and a high frequency power supply for bias application, both of which are connected with the second electrode.

8. The plasma processing apparatus of claim 1, wherein the high frequency power application unit includes a high frequency power supply for plasma generation which is connected with the first electrode and a high frequency power supply for bias application which is connected with the second electrode.
